(19) United States
(12) Patent Application Publication
(10) Pub. No.: US 2015/0145806 A1
(43) Pub. Date: May 28, 2015

(54) IN-CELL TOUCH DISPLAY PANEL AND AN OPERATION METHOD THEREOF

(71) Applicant: HannStar Display Corporation, New Taipei City (TW)

(72) Inventors: Chun-Hsi CHEN, Pingtung County (TW); Jun-Shih CHUNG, Taichung City (TW); Yu-Lung WANG, Tainan City (TW)

(73) Assignee: HannStar Display Corporation, New Taipei City (TW)

(21) Appl. No.: 14/185,902

(22) Filed: Feb. 20, 2014

(30) Foreign Application Priority Data
Nov. 26, 2013 (CN) 201310607124.1

(51) Int. Cl. G02F 1/1333; G06F 3/044

(52) U.S. Cl. CPC G02F 1/13338; G06F 3/044
USPC 345/174

(57) ABSTRACT

The invention relates to an in-cell touch display panel including a thin film transistor array substrate, a color filter substrate, a liquid crystal molecule layer, sensing driving electrodes and touch control sensing electrodes. The liquid crystal molecule layer is disposed between the thin film transistor substrate and the color filter substrate. The sensing driving electrodes are arranged in a first direction and disposed on the thin film transistor array substrate. The touch control sensing electrodes are arranged in a second direction and disposed on a surface of the color filter substrate farther away from the thin film transistor array. The data lines of a pixel array on the thin film transistor array are used as the sensing driving electrodes to cooperate with the touch control sensing electrodes to perform a touch sensing operation.

### RELATED APPLICATIONS

This application claims priority to Chinese Application Serial Number 201310607124.1, filed Nov. 26, 2013, which is herein incorporated by reference.

### BACKGROUND

1. Field of Invention

The invention relates to a touch panel and an operation method thereof, and particularly relates to an in-cell touch panel and an operation method thereof.

2. Description of Related Art

Along with the advance in thin display technology, various thin display devices, having the features of small size, light weight, low radiation and low power consumption, have become a consumer's first choice in selecting a display or TV. Among various display panels of thin display device, a liquid crystal display panel has gradually become more and more popular along with the improvement in the yield rate and the display quality. On the other hand, as the touch control human machine interface technology is now provided, manufacturers are dedicated to the development of touch display panel which integrates a touch control function with a display function.

Of various touch display panels, a in-cell touch display panel, which integrates the touch panel and the display panel into a single touch display panel, effectively reduces the overall thickness of the touch panel, and thus has become a focus of research and development in the field of touch display panel. However, because the sensing electrodes of the in-cell touch display panel are directly disposed in the respective pixels, a part of the aperture ratio of the in-cell touch display panel is sacrificed, thus lowering the transmittance and affecting the display quality.

### SUMMARY

An aspect of the invention provides an in-cell touch display panel including a thin film transistor array substrate, a color filter substrate, a liquid crystal molecule layer, sensing driving electrodes and touch control sensing electrodes. The liquid crystal molecule layer is disposed between the thin film transistor substrate and the color filter substrate. The sensing driving electrodes are arranged in a first direction and disposed on the thin film transistor array substrate. The touch control sensing electrodes are arranged in a second direction and disposed on a surface of the color filter substrate farther away from the thin film transistor array. The data lines of a pixel array on the thin film transistor array are used as the sensing driving electrodes to cooperate with the touch control sensing electrodes to perform a touch sensing operation.

Another aspect of the invention provides a method for driving the aforementioned in-cell touch display panel. The method includes dividing a period of time for using the data lines to charge the pixel array into a display time period and a touch sensing time period. Then, the pixel array is charged by the data lines in the display time period. The data lines stop charging the pixel array in the touch sensing time period to cooperate with the touch control sensing electrodes perform the touch sensing operation.

In and embodiment, the touch sensing time period is further divided by a first time point and a second time point. The data lines are reset to a first voltage at the first time point. The reset voltage in the data lines is transformed to a second voltage at the second time point. There is a first capacitance between each of the touch control sensing electrodes and its corresponding data line.

In an embodiment, capacitances between the touch control sensing electrodes and the data lines are respectively detected. When a capacitance between one of the touch control sensing electrodes and its corresponding data line is not equal to the first capacitance, a touch event is determined to occur on the touch control sensing electrode.

In view of the above, the period of time for using the data lines to charge the pixel array is divided into a display time period and a touch sensing time period for performing a display function and a sensing function respectively. In this method, the data lines disposed in the pixel array can be used as the sensing driving electrodes to cooperate with the touch control sensing electrodes to perform the touch control operation. Because there is no need to form additional electrodes in the pixel array as the sensing driving electrodes, the aperture ratio and transmittance can be kept the same.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 illustrates a top view of an in-cell touch display panel, in which a touch panel and a display panel are integrated into a single touch display panel according to an embodiment of the invention;

FIG. 2 illustrates a cross-sectional view viewed from in FIG. 1 according to an embodiment of the invention;

FIG. 3 illustrates a schematic diagram of a pixel array according to an embodiment of the invention;

FIG. 4 illustrates a schematic timing sequence of a driving signal according to an embodiment of the invention; and

FIG. 5 illustrates a flow chart of performing a touch sensing operation according to an embodiment of the invention.

### DETAILED DESCRIPTION

Specific embodiments of the invention are described in details as follows with reference to the accompanying drawings, wherein throughout the following description and drawings, the same reference numerals refer to the same or similar elements and are omitted when the same or similar elements are stated repeatedly.

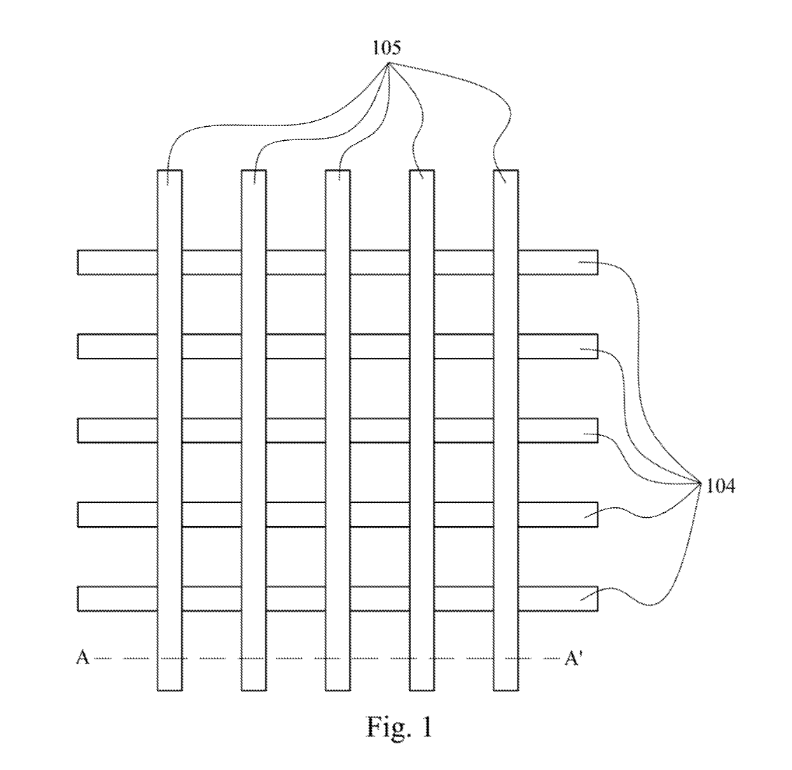

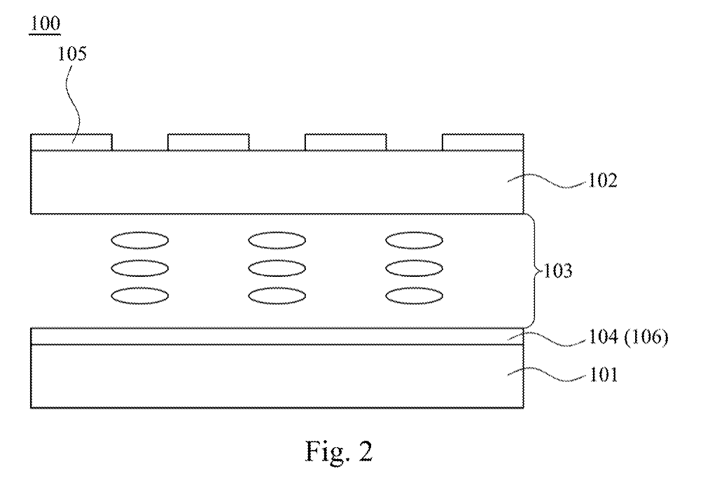

FIG. 1 illustrates a top view of an in-cell touch display panel 100, in which a touch panel and a display panel are integrated into a single touch display panel according to an embodiment of the invention. FIG. 2 illustrates a cross-sectional view viewed from AA′ line in FIG. 1 according to an embodiment of the invention. Please refer to FIG. 1 and FIG. 2 simultaneously.

The in-cell touch display panel 100 includes a thin film transistor (TFT) array substrate 101 a color filter substrate 102, a liquid crystal molecule layer 103, sensing driving electrodes 104 and touch control sensing electrodes 105. The TFT array substrate 101 is disposed opposite to the color filter substrate 102. The liquid crystal molecule layer 103 is disposed between the TFT array substrate 101 and the color filter substrate 102. The TFT array substrate 101 and the color filter substrate 102 are glass substrates or plastic substrates. The sensing driving electrodes 104 are disposed on a surface of the TFT array substrate 101 facing the color filter substrate 102 The sensing driving electrodes 104 are arranged in parallel to each other and along a first direction. The touch control sensing electrodes 105 are disposed on a surface of the color filter substrate 102 father away from the TFT array substrate 101. The touch control sensing electrodes 105 are arranged in parallel to each other and along a second direction. In this embodiment, the data lines disposed in the pixel array 106 on the TFT array substrate 101 are used as the sensing driving electrodes 104. The touch control sensing electrodes 105 cooperates with the sensing driving electrodes 104 to perform a touch control operation. Because there is no additional electrodes formed in the pixel array 106 for the sensing driving electrodes 104, the aperture ratio and transmittance of the display are kept the same. When a touch member, such as a human finger or a pen, touches the panel 100, the touch member acts as a grounding electrode that may cooperate with the touch control sensing electrodes 105 to form a sensing capacitor, so as to change the capacitance between the sensing driving electrodes 104 and the touch control sensing electrodes 105 to sense a touch position, It is noted that, for clarity of explanation, FIG. 1 only illustrates the sensing driving electrodes 104 and the touch control sensing electrodes 105 required for performing a touch control sensing operation. However, one skilled in the art may know that a TFT array substrate 101 a color filter substrate 102 and a liquid crystal molecule layer 103 are also included between the sensing driving electrodes 104 and the touch control sensing electrodes 105.

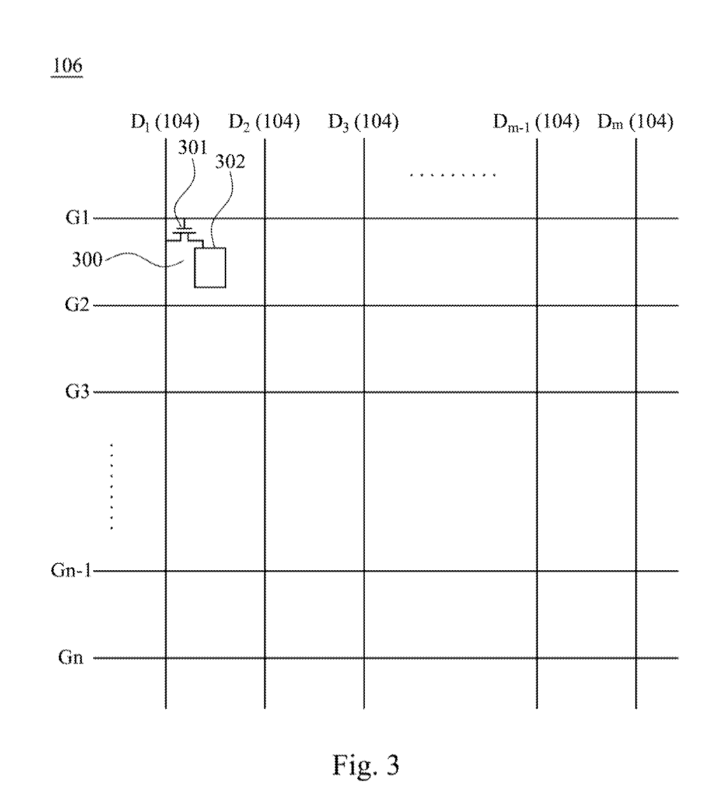

FIG. 3 illustrates a schematic diagram of a pixel array 106 according to an embodiment of the invention. The pixel array 106 includes gate lines G1˜Gn, data lines D1˜Dm, pixel transistors 301 and pixel electrodes 302. The gate lines G1˜Gn are arranged in the second direction and disposed on the TFT array substrate 101. The data lines D1˜Dm are arranged in the first direction and disposed on the TFT array substrate 101. The data lines DI-Dm are used by the sensing driving electrodes 104. The gate lines G1˜Gn are arranged crossing over with the data lines D1˜Dm, thereby dividing the pixel array 106 into pixels 300. Each of the pixels 300 has same structure that includes a pixel transistor 301 and a pixel electrode 302. The pixel transistor 301 in each of the pixels 300 is electrically coupled to a corresponding one of the gate lines G1˜Gn and a corresponding one of the data lines D1˜Dm. Thus, a gate signal transmitted by the corresponding gate line is used to determine whether the pixel transistor 301 is switched on, and a data signal transmitted by the corresponding data line is delivered to the pixel electrode 302 when the pixel transistor 301 is switched on. When the panel 100 is used to display an image, the data lines D1˜Dm are used to transfer data signals. When a touch position on the panel 100 is being detected, the data lines D1˜Dm acts as the sensing driving electrodes 104 to cooperate with the touch control sensing electrodes 105 to form a capacitor to perform a touch control operation. In other words, the period of time for using the data lines D1˜Dm to charge the pixel array 106 is divided into a display time period and a touch sensing time period for performing a display function and a sensing function respectively.

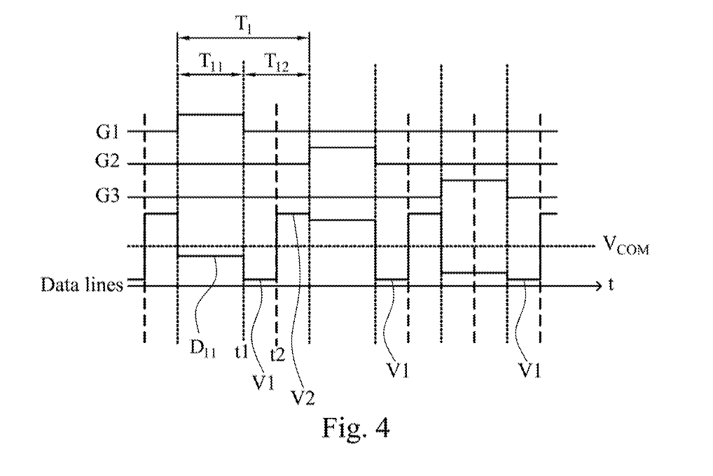

FIG. 4 illustrates a schematic timing sequence of a driving signal according to an embodiment of the invention. Please refer to FIG. 3 and FIG. 4. A period of time T1 for using the data lines D1˜Dm to charge the pixel array 106 is divided into a display time period T11 and a touch sensing time period T12 to perform a display function and a sensing function respectively. In pixel 300, as shown in FIG. 3, when a gate signal is delivered to the gate line G1 the gate signal turns on the pixel transistor 301. Thus, a data signal transmitted by the data line D1 is delivered to the pixel electrode 302 when the pixel transistor 301 is switched on. Because each pixel is not only a display unit but also a touch sensing unit, the pulse width of the gate signal is smaller than the period of time T1 for using the data line to charge the pixel 300 in this embodiment. That is, the gate signal is kept at a high-level state to turn on the pixel transistor 301 to enable the data signal D11 in the data line D1 to charge the pixel electrode 302, so as to display an image in the display time period T11. The gate signal is transformed to a low-level state to turn off the pixel transistor 301 in the touch sensing time period T12. At this time, the image is still displayed in the panel 100 by the storage capacitor (not shown in the FIG. 4) in the pixel 300. Because the pixel transistor 301 is turned off, the display in the panel 100 is not affected by the change in the data lines. Therefore, the touch sensing process can be performed in the time period T12.

Before the touch sensing operation is performed, at a time point t1 in the time period T12, the data line D1 is reset to a reset voltage V1 so as to ensure that the data line D1 acting as the sensing driving electrodes 104 is driven by the same reset voltage V1. Then, at a time point t2 in the time period T12, the reset voltage V1 in the data line D1 is transformed to a second voltage V2 to determine whether the capacitance of the capacitor between the sensing driving electrodes 104 and the touch control sensing electrodes 105 is changed. In this embodiment, the second voltage V2 is greater than the reset voltage V1. However, in another embodiment, the second voltage V2 is smaller than the reset voltage V1. When the sensing driving electrodes 104 is at the second voltage V2 and there is no touch event occurring in the pixel 300, the capacitance of the capacitor between the sensing driving electrodes 104 and the touch control sensing electrodes 105 is not changed. In contrast, when a user's finger touches the pixel 300, the charges stored in the capacitor between the sensing driving electrodes 104 and the touch control sensing electrodes 105 is transferred to the ground through the human body. Therefore, the capacitance of the capacitor between the sensing driving electrodes 104 and the touch control sensing electrodes 105 is changed. The touch control sensing electrodes 105 sense the change of the capacitance to determine the touch position.

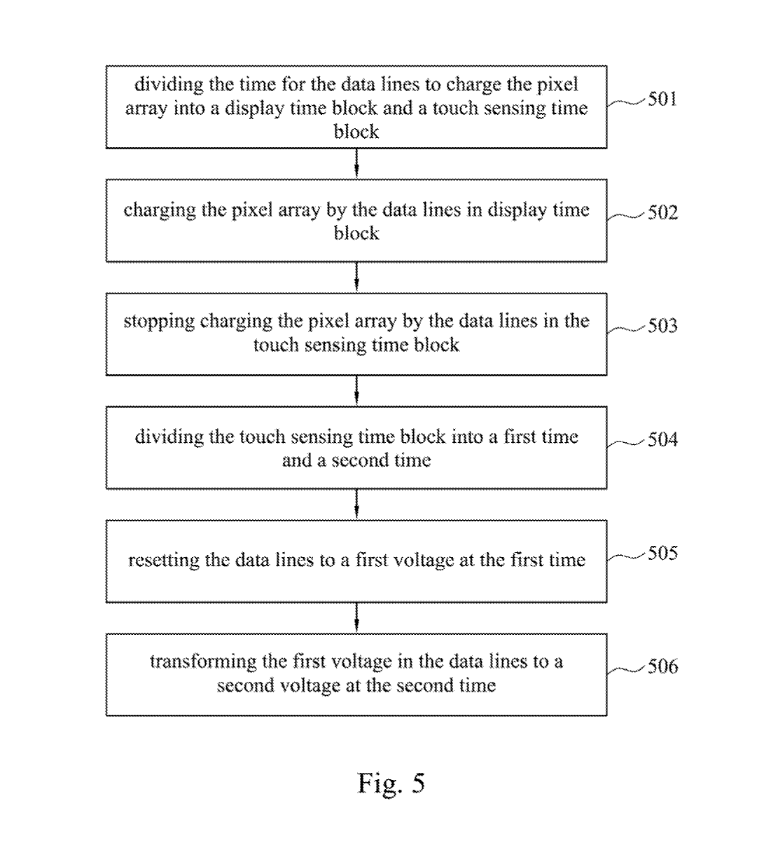

FIG. 5 illustrates a flow chart of performing a touch sensing operation according to an embodiment of the invention. In step 501, the period of time T1 for using the data lines to charge the pixel array is divided into a display time period 111 and a touch sensing time period 112. Then, in step 502, the data lines charge the pixel array in display time period T11. In step 503, the data lines stop charging the pixel array in the touch sensing time period T12. At this time, the data lines cooperate with the touch control sensing electrodes to perform a touch sensing operation. That is, the pixel transistor 301 is turned on in the display time period T11 to enable the data lines to charge the pixel electrodes 302 to display an image on the panel. The pixel transistor 301 is turned off in the touch sensing time period T12. At this time, the image is displayed in the panel 100 by the storage capacitor. Then, a touch sensing process is performed. In step 504, the touch sensing time period 112 is divided by a first time point V1 and a second time point t1. In step 505, at the first time t1, the data line is reset to a first voltage (reset voltage). In step 506, at the second time point t2, the first voltage in the data line is transformed to a second voltage. That is, before performing the touch sensing process, at the first time t1 in the touch sensing time period T12, the data lines D1˜Dm are reset to a first voltage (reset voltage) to ensure the data lines D1˜Dm (the sensing driving electrodes 104) are drove from a same voltage. Then, at the second time t2 in the touch sensing time period T12, the first voltage in the data lines D1˜Dm (the sensing driving electrodes 104) are transformed to a second voltage to determine whether the capacitance of the capacitors between the sensing driving electrodes 104 and the touch control sensing electrodes 105 is changed. A touch event is determined to occur in a touch control sensing electrode when a capacitance between the touch control sensing electrode 104 and corresponding touch control sensing electrodes 105 is changed.

In view of the above, the time for using the data lines to charge the pixel array is divided into a display time period and a touch sensing time period to perform display function and sensing function respectively. In this method, the data lines disposed in the pixel array are used as the sensing driving electrodes to cooperate with the touch control sensing electrodes to perform a touch control operation. Because there is no additional electrodes formed in the pixel array as the sensing driving electrodes, the aperture ratio and transmittance of the display are kept the same.

Although the invention has been disclosed with reference to the above embodiments, these embodiments are not intended to limit the invention. It will be apparent to those of skills in the art that various modifications and variations can be made without departing from the spirit and scope of the invention. Therefore, the scope of the invention shall be defined by the appended claims.

What is claimed is:

1. An in-cell touch display panel, comprising:
a thin film transistor array substrate;
a color filter substrate;
a liquid crystal molecule layer disposed between the thin film transistor substrate and the color filter substrate;
a plurality of sensing driving electrodes arranged in a first direction and disposed on the thin film transistor array substrate; and
a plurality of touch control sensing electrodes arranged in a second direction and disposed on a surface of the color filter substrate farther away from the thin film transistor array,
wherein a plurality of data lines of a pixel array on the thin film transistor array are used as the sensing driving electrodes to cooperate with the touch control sensing electrodes to perform a touch sensing operation.

2. The in-cell touch display panel of claim 1, wherein the sensing driving electrodes cross over the touch control sensing electrodes.

3. The in-cell touch display panel of claim 1, wherein the pixel array further comprises:
a plurality of gate lines arranged in the second direction and disposed on the thin film transistor array substrate; and
a plurality of data lines arranged in the first direction and disposed on the thin film transistor array substrate, wherein the data lines are used as the sensing driving electrodes to cooperate with the touch control sensing electrodes to perform the touch sensing operation, wherein the gate lines cross over the data lines to divide the pixel array into a plurality of pixels, wherein each of the pixels further comprises:
a pixel transistor electrically coupled to a corresponding gate line and a corresponding data line; and
a pixel electrode coupled to the pixel transistor, wherein the corresponding data line delivers a data signal to the pixel electrode when the pixel transistor is switched on, and the corresponding data line and the touch control sensing electrode perform the touch sensing operation when the pixel transistor is not switched on.

4. A method for driving the in-cell touch display panel of claim 1, the method comprising:
dividing a period of time for using the data lines to charge the pixel array into a display time period and a touch sensing time period;
charging the pixel array by the data lines in the display time period; and
stopping charging the pixel array by the data lines in the touch sensing time period, the data lines and the touch control sensing electrodes performing the touch sensing operation together.

5. The method of claim 4, wherein the operation of the data lines and the touch control sensing electrodes performing the touch sensing process together further comprises:
dividing the touch sensing time period by a first time point and a second time point;
resetting the data lines to a first voltage at the first time point; and
transforming the first voltage of the data lines to a second voltage at the second time point, wherein there is a first capacitance between each of the touch control sensing electrodes and its corresponding data line.

6. The method of claim 5, wherein the second voltage is greater than the first voltage.

7. The method of claim 5, wherein the second voltage is smaller than the first voltage.

8. The method of claim 5, further comprising:
respectively detecting capacitances between the touch control sensing electrodes and the data lines; and
determining a touch event occurring on a touch control sensing electrode when a capacitance between one of the touch control sensing electrodes and its corresponding data line is not equal to the first capacitance.
